(19) United States
(12) Patent Application Publication
(10) Pub. No.: US 2018/0240422 A1
(43) Pub. Date: Aug. 23, 2018

(54) LIQUID CRYSTAL DRIVING DEVICE, ELECTRONIC WATCH, LIQUID CRYSTAL DRIVING METHOD, AND RECORDING MEDIUM

(71) Applicant: CASIO COMPUTER CO., LTD., Tokyo (JP)

(72) Inventors: Tatsuyoshi OMURA, Kodaira-shi (JP); Eiji YAMAKAWA, Tama-shi (JP); Jyunichi HIROKAWA, Akishima-shi (JP); Takahiro ONO, Akishima-shi (JP)

(21) Appl. No.: 15/895,071

(22) Filed: Feb. 13, 2018

(30) Foreign Application Priority Data
Feb. 17, 2017 (JP) 2017-027670

(51) Int. Cl. G09G 3/36

(52) U.S. Cl. CPC G09G 3/3614; G09G 2300/0842; G09G 2310/08

(57) ABSTRACT

An electronic watch includes a liquid crystal driver to drive a liquid crystal panel in which a plurality of pixels are arranged, and a CPU to control the liquid crystal driver. The CPU instructs the liquid crystal driver to output image data to the pixels. The CPU instructs the liquid crystal driver to output AC voltage while reversing the polarity of the AC voltage in predetermined cycles to be applied to display elements included in the respective pixels. When a timing of reversing the polarity is within a period of output of the image data, the CPU delays the timing until after the period.

### CROSS-REFERENCE TO RELATED APPLICATION

This application claims the benefit of Japanese Patent Application No. 2017-027670, filed on Feb. 17, 2017, the entire disclosure of which is incorporated by reference herein.

### FIELD

This application relates to a liquid crystal driving device, an electronic watch, a liquid crystal driving method, and a recording medium.

### BACKGROUND

For example, Unexamined Japanese Patent Application Kokai Publication No. 2003-177717 discloses a liquid crystal display (LCD) device including a liquid crystal panel in which pixels for displaying an image are arranged. The pixels each include a memory element to store image data. This configuration can reduce the frequency of replacement of the displayed image and thereby reduce the electric power consumption at the liquid crystal panel.

In a typical LCD device, such as one disclosed in the above-mentioned patent literature, the liquid crystal panel is driven by AC voltage of which the polarity is reversed in predetermined cycles, because a liquid crystal panel driven by a DC voltage has a shorter service life. Unfortunately, if the timing of outputting image data to pixels overlaps with the timing of reversing the polarity of the AC voltage, the memory elements in the pixels may fail to successfully record the image data, resulting in a reduction in the reliability of the liquid crystal panel.

### SUMMARY

The present disclosure can provide a liquid crystal driving device, an electronic watch, a liquid crystal driving method, and a recording medium.

The liquid crystal driving device according to a preferred embodiment, which has been accomplished to solve the above problems, includes: a liquid crystal driver that drives a liquid crystal panel in which a plurality of pixels are arranged; and a processor that controls the liquid crystal driver. The processor instructs the liquid crystal driver to output image data to the pixels, and instructs the liquid crystal driver to output AC voltage while reversing the polarity of the AC voltage in predetermined cycles, the AC voltage being applied to display elements included in the respective pixels. If a timing of reversing the polarity is within a period of output of the image data, the processor delays the timing until after the period.

### BRIEF DESCRIPTION OF THE DRAWINGS

A more complete understanding of this application can be obtained when the following detailed description is considered in conjunction with the following drawings, in which:

FIG. 1 illustrates an exemplary configuration of an electronic watch according to a first embodiment;

FIG. 2 is a circuit diagram illustrating exemplary configurations of a liquid crystal driver and a liquid crystal panel according to the first embodiment;

FIG. 3 is a diagram for describing the relationship between image data output periods and timings of reversing the polarity of AC voltage according to the first embodiment;

FIG. 4 is a flowchart illustrating the steps of an AC-voltage output control process executed by a CPU of the electronic watch according to the first embodiment;

FIG. 5 is a flowchart illustrating the steps of an image-data output control process executed by the CPU of the electronic watch according to the first embodiment;

FIG. 6 illustrates an exemplary image displayed on a liquid crystal panel according to a second embodiment;

FIG. 7 illustrates an exemplary configuration of an electronic watch according to the second embodiment;

FIG. 8 is a diagram for describing the relationship between an image data output period and timings of reversing the polarity of AC voltage according to the second embodiment;

FIG. 9 is a flowchart illustrating the steps of an image-data output control process executed by a CPU of the electronic watch according to the second embodiment; and

FIG. 10 illustrates an exemplary configuration of an electronic watch according to a third embodiment.

### DETAILED DESCRIPTION

Embodiments of the present disclosure will now be described with reference to the following drawings.

### First Embodiment

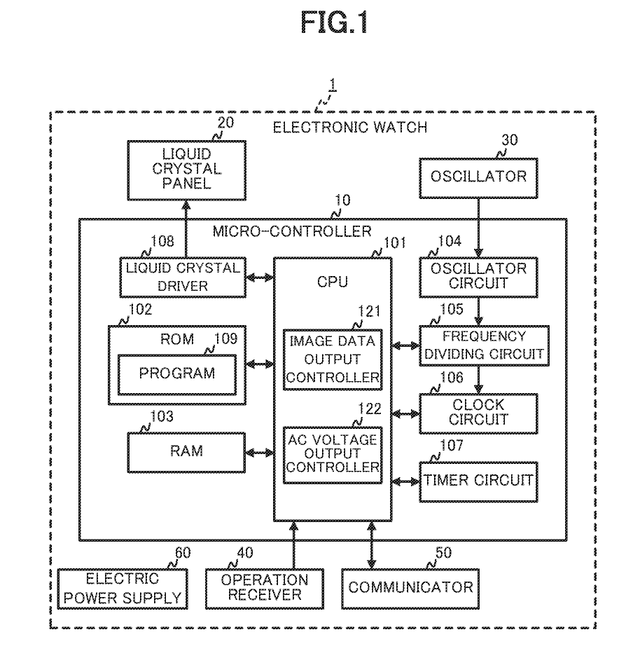

FIG. 1 illustrates an exemplary configuration of an electronic watch 1 according to a first embodiment. First, the hardware configuration of the electronic watch 1 according to the first embodiment will be described. With reference to FIG. 1, the electronic watch 1 includes a micro-controller 10, a liquid crystal panel 20, an oscillator 30, an operation receiver 40, a communicator 50, and an electric power supply 60.

The micro-controller 10 is an exemplary liquid crystal driving device according to preferred embodiments. The micro-controller 10 includes a central processing unit (CPU) 101 serving as a processor, a read only memory (ROM) 102, a random access memory (RAM) 103, an oscillator circuit 104, a frequency dividing circuit 105, a clock circuit 106, a timer circuit 107, and a liquid crystal driver 108. The ROM 102, the RAM 103, the oscillator circuit 104, the frequency dividing circuit 105, the clock circuit 106, the timer circuit 107, and the liquid crystal driver 108 may also be provided outside the micro-controller 10 instead of inside the micro-controller 10. Furthermore, the oscillator 30, the communicator 50, and the electric power supply 60 may be provided inside the micro-controller 10 instead of outside the micro-controller 10.

The CPU 101 is a processor for various calculations and comprehensive control of the entire operation of the electronic watch 1. The CPU 101 reads a control program from the ROM 102 and loads the program into the RAM 103, to execute various operational processes, such as calculation control and display control associated with various functions.

The ROM 102 is, for example, a non-volatile memory for storing the control program and initial setting data. The control program contains a program 109 for the control of an AC-voltage output control process and an image-data output control process (which will be explained later) to drive the liquid crystal panel 20.

The RAM 103 is a volatile memory, such as a static random access memory (SRAM) or a dynamic random access memory (DRAM). The RAM 103 stores temporary data and various setting data. The RAM 103 also stores image data to be output to the liquid crystal panel 20. In this embodiment, the image data indicates a date, day of week, current time, and remaining battery level, for example.

The oscillator circuit 104 causes oscillation of the oscillator 30, and thereby generates and outputs a signal (clock signal) at a certain frequency.

The frequency dividing circuit 105 divides the frequency of the clock signal input from the oscillator circuit 104 and outputs a signal at a certain frequency to be used at the clock circuit 106 or the CPU 101. The frequency of the output signal may be varied based on the determination by the CPU 101.

The clock circuit 106 determines a current time by counting the number of signal inputs from the frequency dividing circuit 105 and adding the counted number to the initial value. The clock circuit 106 may be configured by software for varying the value stored in the RAM 103 or may be configured by dedicated hardware. The clock circuit 106 may determine any type of time, such as an accumulated time from a certain timing, coordinated universal time (UTC), or time (local time) in a predetermined city. The time determined by the clock circuit 106 is not necessarily represented in the form of year, month, day, hour, minute, and second.

In this embodiment, the oscillator circuit 104, the frequency dividing circuit 105, and the clock circuit 106 serve as a counter.

The timer circuit 107 counts cycles of reversing the polarity of the AC voltage as interrupt cycles (for example, 0.5-second cycles). In response to the elapse of an interrupt cycle from the start of counting the interrupt cycle, the timer circuit 107 outputs an interrupt request signal to the CPU 101. The interrupt cycle is preliminarily determined by the CPU 101, for example.

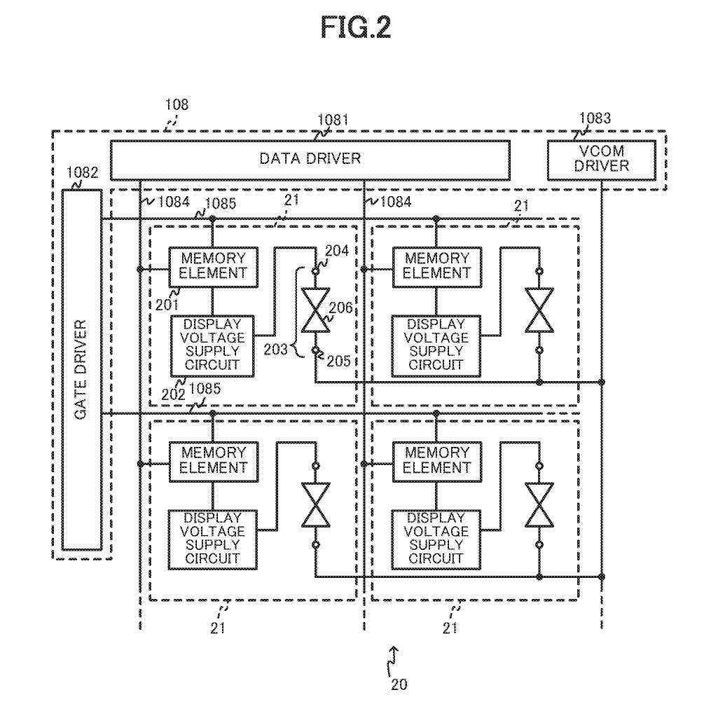

The liquid crystal driver 108 outputs drive signals for driving the liquid crystal panel 20 to the liquid crystal panel 20 based on control signals from the CPU 101, to cause the liquid crystal panel 20 to display time and various functions. In detail, with reference to FIG. 2, the liquid crystal driver 108 includes a data driver 1081, a gate driver 1082, and a VCOM driver 1083. The data driver 1081 outputs data signals to data bus lines 1084 based on the clock signal and the control signal from the CPU 101. The gate driver 1082 outputs scan signals to gate bus lines 1085 based on the clock signal and the control signal from the CPU 101. The VCOM driver 1083 outputs AC voltage (VCOM) to be applied to display elements 203 (described below) based on the control signal from the CPU 101. In this embodiment, the polarity of the AC voltage is reversed at timings determined by the CPU 101.

The liquid crystal panel 20 performs digital display operation for displaying data on time and various functions. In this embodiment, the liquid crystal panel 20 is a memory-in-pixel (MIP) liquid crystal display (LCD) in which pixels arranged in matrix each include a memory element for storing data for that pixel.

FIG. 2 is a schematic diagram of circuitry constituting the liquid crystal driver 108 and the liquid crystal panel 20 according to this embodiment. With reference to FIG. 2, pixels 21 of the liquid crystal panel 20 each include a memory element 201, a display voltage supply circuit 202, and a display element 203. The display element 203 includes a pixel electrode 204, a common electrode 205, and liquid crystals 206. In order to display an image on each pixel 21, the gate driver 1082 outputs a scan signal to the gate bus line 1085 that covers the pixel 21 whereas the data driver 1081 outputs a data signal. The output data signal is then recorded in the memory element 201 in the pixel 21. The display voltage supply circuit 202 then supplies the voltage, corresponding to the data signal recorded in the memory element 201, to the pixel electrode 204. The image is then displayed based on the voltage between the pixel electrode 204 and the common electrode 205 to which the VCOM driver 1083 applies AC voltage. If the displayed image does not need to be replaced, the display voltage supply circuits 202 supply electric potentials to the respective pixel electrodes 204, whereas the data driver 1081 and the gate driver 1082 halt their operations. In contrast, if the displayed image needs to be replaced, the data driver 1081 and the gate driver 1082 are activated to update the data signals recorded in the respective memory elements 201. These operations can reduce the frequency of replacement of the displayed image and thereby reduce the electric power consumption, in comparison to a typical thin film transistor (TFT) LCD.

Referring back to FIG. 1, the oscillator 30 is a crystal oscillator, for example, and generates a signal at its own frequency in cooperation with the oscillator circuit 104.

The operation receiver 40 receives an input operation from a user and outputs an electrical signal (input signal) corresponding to the input operation to the micro-controller 10. The operation receiver 40 includes, for example, a push-button switch and a winding crown. Alternatively, the operation receiver 40 may be a touch sensor overlapping with the display screen of the liquid crystal panel 20 so that the touch sensor and the display screen constitute a touch panel. In this case, the touch sensor detects the position and mode of a touch operation of the user on the touch sensor, and outputs an operational signal, corresponding to the detected position and mode of the touch operation, to the CPU 101.

The communicator 50 includes, for example, a radio frequency (RF) circuit, a baseband (BB) circuit, and a memory circuit. The communicator 50 transmits and receives radio signals based on the Bluetooth (registered trademark) low energy (BLE) technology, for example. The communicator 50 processes the received radio signals through an operation, such as demodulation and decoding, and transmits the resulting signals to the CPU 101. The communicator 50 also processes signals received from the CPU 101 through an operation, such as coding and modulation, and transmits the resulting signals to an external device.

The electric power supply 60 includes, for example, a battery and a voltage converter circuit. The electric power supply 60 supplies electric power at an operating voltage of each component of the electronic watch 1. The battery of the electric power supply 60 in this embodiment is a primary battery, such as a button buttery. The battery of the electric power supply 60 may also be a solar panel and a secondary battery.

The functional configuration of the CPU 101 of the electronic watch 1 according to the first embodiment will now be described. With reference to FIG. 1, the CPU 101 serves as an image data output controller 121 and an AC voltage output controller 122. The functions of the image data output controller 121 and the AC voltage output controller 122 may be performed by a single CPU 101 or separate CPUs 101. Alternatively, the functions may be performed by another processor, such as a CPU (not shown) of the communicator 50, in place of the CPU 101.

The CPU 101 functioning as the image data output controller 121 instructs the liquid crystal driver 108 to output image data to the pixels 21. In specific, for example, in response to reception of an image output request from the operation receiver 40 or an application being executed by the CPU 101, the CPU 101 generates image data to be output and records the image data into the RAM 103. The CPU 101 then turns on an image-data output continuation flag. The image-data output continuation flag indicates whether any image data is being output to the pixels 21. The ON state of the flag indicates continuation of output of image data to the pixels 21, whereas the OFF state indicates halt of output of image data to the pixels 21. After turning on the image-data output continuation flag, the CPU 101 instructs the liquid crystal driver 108 to output the image data recorded in the RAM 103 to the pixels 21. After completion of output of the image data to the pixels 21, the CPU 101 turns off the image-data output continuation flag. In the following description, the period from the start of output of image data to the pixels 21 until the end of the output, that is, the period in which the image data is being output is referred to as “image data output period.”

The CPU 101 functioning as the AC voltage output controller 122 instructs the liquid crystal driver 108 to output AC voltage while reversing the polarity of the AC voltage in the interrupt cycles (certain cycles) to be applied to the display elements 203 included in the respective pixels 21. If a desired timing of reversing the polarity of the AC voltage is within an image data output period, the CPU 101 delays the timing until after the image data output period. For example, in response to reception of an interrupt request signal in the ON state of the image-data output continuation flag, the CPU 101 turns on a polarity reversal delay flag and instructs the liquid crystal driver 108 to output AC voltage while maintaining the polarity. After the image data output period in the ON state of the polarity reversal delay flag, the CPU 101 instructs the liquid crystal driver 108 to output the AC voltage with the reversed polarity. In contrast, in response to reception of an interrupt request signal in the OFF state of the image-data output continuation flag, the CPU 101 instructs the liquid crystal driver 108 to output the AC voltage with the reversed polarity.

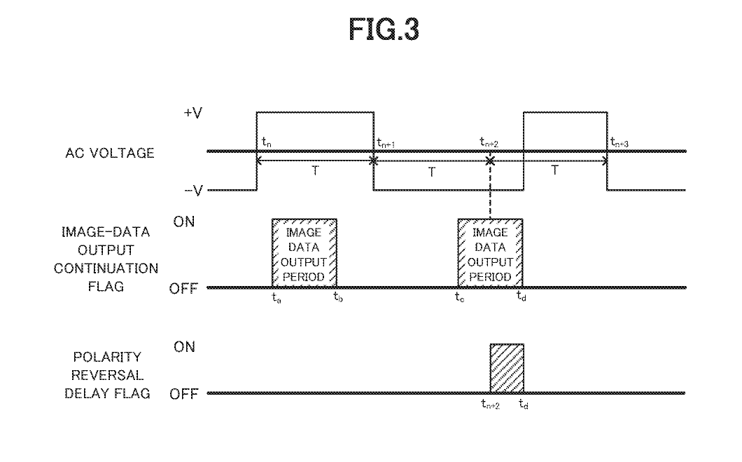

The relationship between image data output periods and timings of reversing the polarity of the AC voltage according to this embodiment will now be described with reference to FIG. 3. The upper part of FIG. 3 illustrates an output of the AC voltage, the middle part illustrates a state of the image-data output continuation flag, and the lower part illustrates a state of the polarity reversal delay flag. For example, at a time tₙ of reception of an interrupt request signal, the CPU 101 determines that the image-data output continuation flag is OFF, and instructs the liquid crystal driver 108 to output the AC voltage with the reversed polarity. The liquid crystal driver 108 then reverses the polarity of the AC voltage from −V to +V and outputs the AC voltage. At a time tₐ (tₙ<tₐ<tₙ₊₁) of reception of an image output request, the CPU 101 generates image data, turns on the image-data output continuation flag, and instructs the liquid crystal driver 108 to output the generated image data to the pixels 21. At a time t_{b}<t_{b}<tₙ₊₁) of completion of output of the image data to the pixels 21, the CPU 101 turns off the image-data output continuation flag.

At a time tₙ₊₁ (after the elapse of an interrupt cycle T from the time tₙ) of reception of an interrupt request signal, the CPU 101 determines that the image-data output continuation flag is OFF, and instructs the liquid crystal driver 108 to output the AC voltage with the reversed polarity. The liquid crystal driver 108 then reverses the polarity of the AC voltage from +V to −V and outputs the AC voltage. At a time t_{c} (tₙ₊₁<t_{c}<tₙ₊₂) of reception of an image output request, the CPU 101 generates image data, turns on the image-data output continuation flag, and instructs the liquid crystal driver 108 to output the generated image data to the pixels 21. At a time tₙ₊₂ (after the elapse of the interrupt cycle T from the time tₙ₊₁) of reception of an interrupt request signal, the CPU 101 determines that the image-data output continuation flag is ON, turns on the polarity reversal delay flag, and instructs the liquid crystal driver 108 to output the AC voltage while maintaining the polarity.

At a time t_{d} (tₙ₊₂<t_{d}<tₙ₊₃) of completion of output of the image data to the pixels 21, the CPU 101 turns off the image-data output continuation flag. The CPU 101 determines that the polarity reversal delay flag is ON, and instructs the liquid crystal driver 108 to output the AC voltage with the reversed polarity. The liquid crystal driver 108 then reverses the polarity of the AC voltage from —V to +V and outputs the AC voltage. The CPU 101 then turns off the polarity reversal delay flag. At a time tₙ₊₃ (after the elapse of the interrupt cycle T from the time tₙ₊₂) of reception of an interrupt request signal, the CPU 101 determines that the image-data output continuation flag is OFF, and instructs the liquid crystal driver 108 to output the AC voltage with the reversed polarity. The liquid crystal driver 108 then reverses the polarity of the AC voltage from +V to −V and outputs the AC voltage.

As described above, in response to reception of an interrupt request signal (corresponding to a desired timing of reversing the polarity of the AC voltage), the CPU 101 checks for the image-data output continuation flag to determine whether the current time is within the image data output period. In the ON state of the image-data output continuation flag, the CPU 101 determines that the current time is within the image data output period, and instructs the liquid crystal driver 108 to output the AC voltage while maintaining the polarity. After the image data output period, the CPU 101 instructs the liquid crystal driver 108 to output the AC voltage with the reversed polarity. That is, if the desired timing of reversing the polarity of the AC voltage is within the image data output period, the CPU 101 delays the timing until after the image data output period.

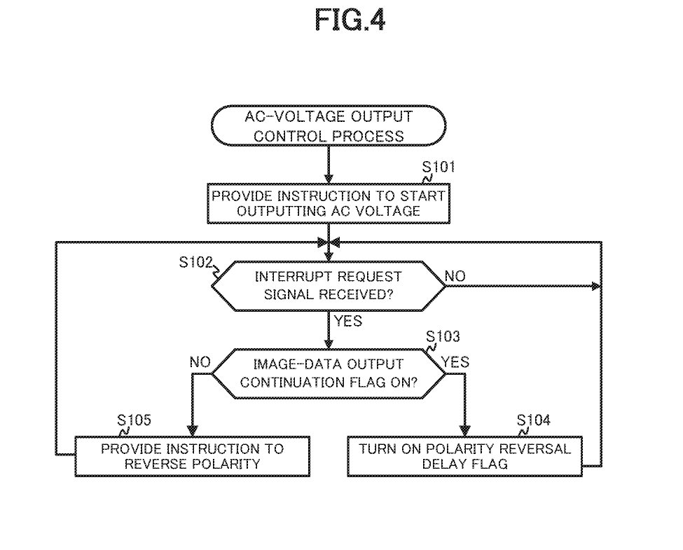

FIG. 4 is a flowchart illustrating the steps of the AC-voltage output control process executed by the CPU 101 of the electronic watch 1. The AC-voltage output control process is one embodiment of the liquid crystal driving method in the present disclosure. The CPU 101 starts the AC-voltage output control process, for example, in response to reception of an instruction to start the process from the operation receiver 40.

At the start of the AC-voltage output control process, the CPU 101 instructs the liquid crystal driver 108 to start outputting AC voltage with the initial polarity (Step S101). The initial polarity is preliminarily set to +V, for example.

The CPU 101 then determines whether the CPU 101 has received an interrupt request signal (Step S102). For example, interrupt request signals are output from the timer circuit 107 in the interrupt cycles (for example, 0.5-second cycles). The CPU 101 waits until receiving an interrupt request signal (Step S102; No).

If determining that the CPU 101 has received an interrupt request signal (Step S102; Yes), the CPU 101 determines whether the image-data output continuation flag is ON (Step S103).

If determining that the image-data output continuation flag is ON (Step S103; Yes), the CPU 101 turns on the polarity reversal delay flag (Step S104). The CPU 101 then returns to Step S102.

If determining that the image-data output continuation flag is OFF (Step S103; No), the CPU 101 instructs the liquid crystal driver 108 to reverse the polarity of the AC voltage (Step S105). The CPU 101 then returns to Step S102.

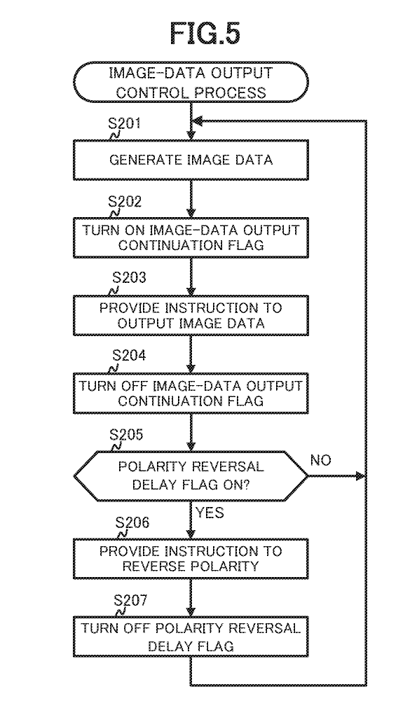

FIG. 5 is a flowchart illustrating the steps of the image-data output control process executed by the CPU 101 of the electronic watch 1. The image-data output control process is one embodiment of the liquid crystal driving method in the present disclosure. The CPU 101 starts the image-data output control process, for example, in response to reception of an instruction to start the process from the operation receiver 40.

At the start of the image-data output control process, the CPU 101 generates image data to be output to the liquid crystal panel 20 (Step S201). The CPU 101 then records the generated image data into the RAM 103.

The CPU 101 turns on the image-data output continuation flag (Step S202). The CPU 101 then instructs the liquid crystal driver 108 to output the image data generated in Step S201 (Step S203). After completion of output of the image data, the CPU 101 turns off the image-data output continuation flag (Step S204).

The CPU 101 then determines whether the polarity reversal delay flag is ON (Step S205). If the polarity reversal delay flag is OFF (Step S205; No), the CPU 101 returns to Step S201.

If the polarity reversal delay flag is ON (Step S205; Yes), the CPU 101 instructs the liquid crystal driver 108 to reverse the polarity of the AC voltage (Step S206). The CPU 101 then turns off the polarity reversal delay flag (Step S207) and returns to Step S201.

As described above, if a desired timing of reversing the polarity of the AC voltage is within an image data output period, the CPU 101 of the electronic watch 1 according to the first embodiment delays the timing until after the image data output period. This configuration can prevent an error in image replacement caused by unsuccessful recording of image data into the memory elements 201 in the pixels 21 due to reversal of the polarity of the AC voltage during the image data output period. The configuration therefore can prevent a reduction in the reliability of the liquid crystal panel 20.

In addition, the CPU 101 of the electronic watch 1 according to the first embodiment turns on the image-data output continuation flag at the start of output of image data. If the CPU 101 determines that the image-data output continuation flag is ON at a desired timing of reversing the polarity of the AC voltage, the CPU 101 delays the timing until after the image data output period. That is, the CPU 101 can determine that the current time is within the image data output period based on the image-data output continuation flag, and therefore prevent reversal of the polarity of the AC voltage during the image data output period.

Furthermore, if a desired timing of reversing the polarity of the AC voltage is within an image data output period, the CPU 101 of the electronic watch 1 according to the first embodiment turns on the polarity reversal delay flag and instructs the liquid crystal driver 108 to output the AC voltage while maintaining the polarity. In this case, the CPU 101 determines that the polarity reversal delay flag is ON after the image data output period, and then instructs the liquid crystal driver 108 to output the AC voltage with the reversed polarity. That is, the CPU 101 can determine that the polarity of the AC voltage was not reversed at the desired timing during the image data output period based on the polarity reversal delay flag, and reverse the polarity of the AC voltage after the image data output period.

### Second Embodiment

An electronic watch 1a according to a second embodiment will now be described. In the first embodiment, if a desired timing of reversing the polarity of the AC voltage is within an image data output period, the CPU 101 of the electronic watch 1 delays the timing until after the image data output period. The timing of reversing the polarity of the AC voltage may also be varied by any other procedure. In the second embodiment, image data indicates an image containing a plurality of image segments, and a desired timing of reversing the polarity of the AC voltage is delayed until after completion of output of part of the image data indicating one of the image segments.

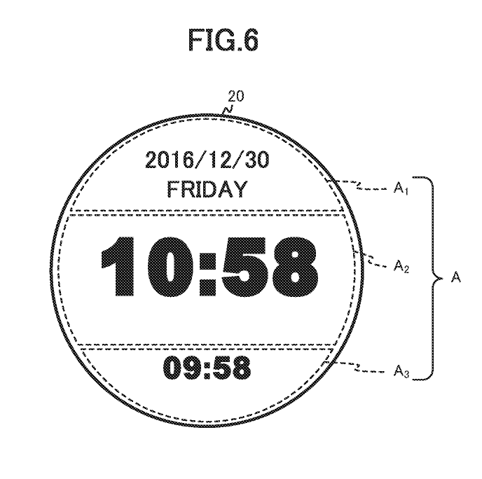

First, an image indicated by image data to be output to the liquid crystal panel 20 will now be described according to the second embodiment. In the second embodiment, the image indicated by the image data to be output to the liquid crystal panel 20 contains a plurality of image segments. The image segments each represent certain information. FIG. 6 illustrates an exemplary image A displayed on the liquid crystal panel 20 according to the second embodiment. The image A illustrated in FIG. 6 contains three image segments A₁ to A₃. The image segment A₁ represents the current date and day of the week. The image segment A₂ represents the current time in the time zone where a user is located. The image segment A₃ represents the current time in another time zone different from the time zone where the user is located.

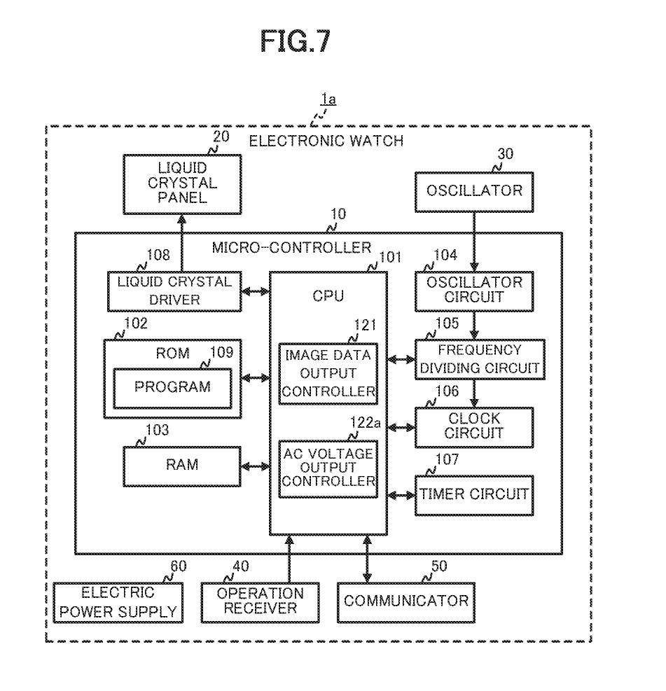

Next, the configuration of the electronic watch 1a will now be described according to the second embodiment. FIG. 7 illustrates an exemplary configuration of the electronic watch la according to the second embodiment. The configuration of the electronic watch 1a is identical to that of the electronic watch 1 according to the first embodiment, except that the CPU 101 in the second embodiment serves as an AC voltage output controller 122a instead of the AC voltage output controller 122 in the first embodiment. The components identical to those in the first embodiment are provided with the same reference signs without redundant description.

If a desired timing of reversing the polarity of the AC voltage is within a period of output of image data indicating one of the image segments A₁ to A₃, the CPU 101 serving as the AC voltage output controller 122a delays the timing until after completion of output of the image data indicating the one image segment. For example, in response to reception of an interrupt request signal in the ON state of the image-data output continuation flag, the CPU 101 turns on the polarity reversal delay flag and instructs the liquid crystal driver 108 to output the AC voltage while maintaining the polarity, as in the first embodiment. In response to reception of an interrupt request signal in the OFF state of the image-data output continuation flag, the CPU 101 instructs the liquid crystal driver 108 to output the AC voltage with the reversed polarity, as in the first embodiment. In this case, after completion of output of image data indicating one of the image segments A₁ to A₃ in the ON state of the polarity reversal delay flag, the CPU 101 instructs the liquid crystal driver 108 to reverse the polarity of the AC voltage.

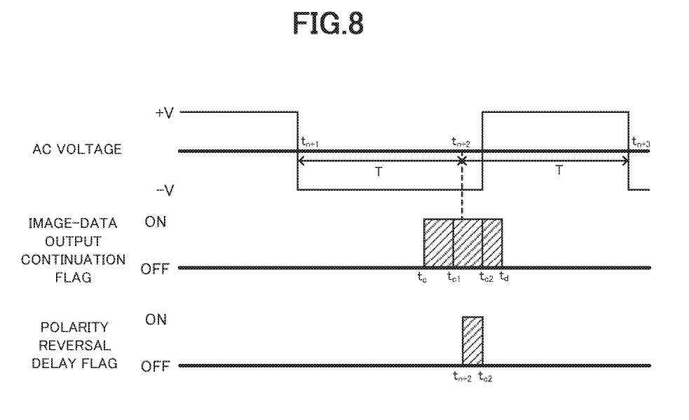

The relationship between an image data output period and timings of reversing the polarity of the AC voltage according to this embodiment will now be described with reference to FIG. 8. The upper part of FIG. 8 illustrates an output of the AC voltage, the middle part illustrates a state of the image-data output continuation flag, and the lower part illustrates a state of the polarity reversal delay flag. For example, at a time tₙ₊₁ of reception of an interrupt request signal, the CPU 101 determines that the image-data output continuation flag is OFF, and instructs the liquid crystal driver 108 to output the AC voltage with the reversed polarity. The liquid crystal driver 108 then reverses the polarity of the AC voltage from +V to −V and outputs the AC voltage. At a time tc of reception of an image output request, the CPU 101 generates image data, turns on the image-data output continuation flag, and instructs the liquid crystal driver 108 to output the generated image data to the pixels 21. The liquid crystal driver 108 then outputs image data indicating the image segment A₁ from the time t_{c} to a time t_{c1} (t_{c}<t_{c1}<tₙ₊₂) in the image data output period, outputs image data indicating the image segment A₂ from the time t_{c1} to a time t_{c1} (tₙ₊₂<t_{c2}<t_{d}) in the image data output period, and outputs image data indicating the image segment A₃ from the time t_{c2} to a time t_{d} in the image data output period, to the pixels 21.

At a time tₙ₊₂ of reception of an interrupt request signal, the CPU 101 determines that the image-data output continuation flag is ON, turns on the polarity reversal delay flag, and instructs the liquid crystal driver 108 to output the AC voltage while maintaining the polarity. At the time t_{c2} of completion of output of the image data indicating the image segment A₂, the

CPU 101 determines that the polarity reversal delay flag is ON, and supplies a control signal to the liquid crystal driver 108 to instruct the liquid crystal driver 108 to output the AC voltage with the reversed polarity. The liquid crystal driver 108 then reverses the polarity of the AC voltage from −V to +V and outputs the AC voltage. The CPU 101 then turns off the polarity reversal delay flag. At the time t_{d} of completion of output of the entire image data indicating all the image segments A₁ to A₃, the CPU 101 turns off the image-data output continuation flag. At a time tₙ₊₃ of reception of an interrupt request signal, the CPU 101 determines that the image-data output continuation flag is OFF, and instructs the liquid crystal driver 108 to output the AC voltage with the reversed polarity. The liquid crystal driver 108 then reverses the polarity of the AC voltage from +V to −V and outputs the AC voltage.

As described above, if the CPU 101 according to the second embodiment receives an interrupt request signal (corresponding to a desired timing of reversing the polarity of the AC voltage) during the period of output of the image data indicating the image segment A₂ among the image segments A₁ to A₃, then the CPU 101 instructs the liquid crystal driver 108 to output the AC voltage while maintaining the polarity. Then, after the period of output of the image data indicating the image segment A₂, the CPU 101 instructs the liquid crystal driver 108 to output the AC voltage with the reversed polarity. The delay in the timing of reversing the polarity of the AC voltage is (t_{c2}−tₙ₊₂) in the second embodiment, whereas the delay is (t_{d}−tₙ₊₂) in the first embodiment. That is, the configuration of the second embodiment can reduce the delay in the timing of reversing the polarity of the AC voltage in comparison to that in the first embodiment.

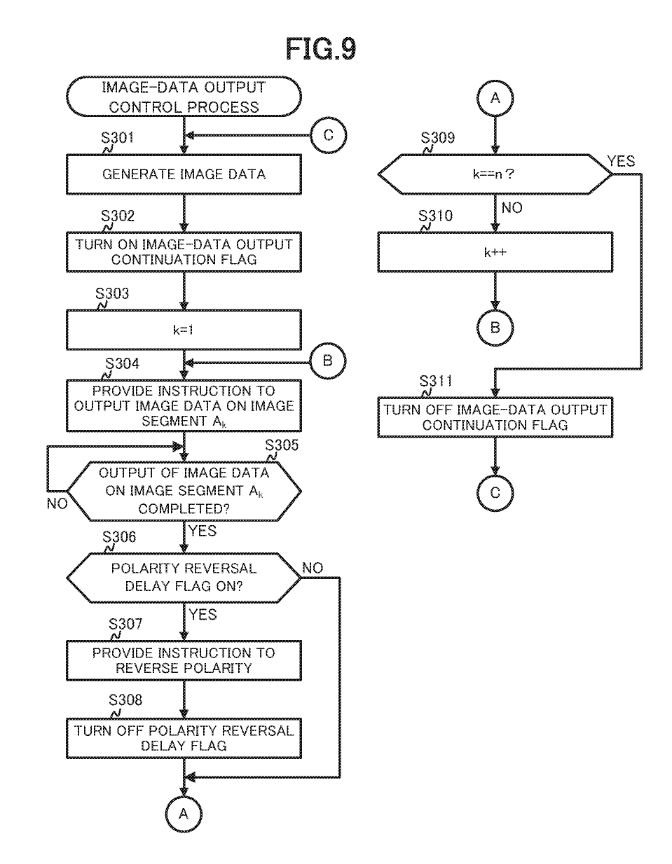

FIG. 9 is a flowchart illustrating the steps of the image-data output control process executed by the CPU 101 of the electronic watch 1a according to this embodiment. The image-data output control process is one embodiment of the liquid crystal driving method in the present disclosure. The CPU 101 starts the image-data output control process, for example, in response to reception of an instruction to start the process from the operation receiver 40. This flowchart is based on an example where image data indicates an image containing n image segments A₁ to Aₙ.

At the start of the image-data output control process, the CPU 101 executes Steps S301 and S302, as in Steps S201 and S202 of the image-data output control process according to the first embodiment as illustrated in FIG. 5.

The CPU 101 sets a counter k, for counting the number of image segments contained in an image indicated by image data, to be 1 (initial value) (Step S303). The CPU 101 then instructs the liquid crystal driver 108 to output image data indicating an image segment Ak, which is part of the image data generated in Step S301 (Step S304).

The CPU 101 determines whether the output of the image data indicating the image segment Aₖ has been completed (Step S305). The CPU 101 waits until the completion of output of the image data indicating the image segment Aₖ (Step S305; No).

If determining the completion of output of the image data indicating the image segment Aₖ (Step S305; Yes), the CPU 101 determines whether the polarity reversal delay flag is ON (Step S306). If determining that the polarity reversal delay flag is OFF (Step S306; No), the CPU 101 proceeds to Step S309.

If determining that the polarity reversal delay flag is ON (Step S306; Yes), the CPU 101 instructs the liquid crystal driver 108 to reverse the polarity of the AC voltage (Step

S307). The CPU 101 then turns off the polarity reversal delay flag (Step S308).

The CPU 101 determines whether the counter k is n (Step S309). In other words, the CPU 101 determines whether the entire image data indicating all the image segments A₁ to Aₖ has been output. If determining that the counter k is not n (Step S309; No), the CPU 101 increments the counter k (Step S310), and returns to Step S304.

If determining that the counter k is n (Step S309; Yes), the CPU 101 turns off the image-data output continuation flag (Step S311), and returns to Step S301.

As described above, if a desired timing of reversing the polarity of the AC voltage is within a period of output of image data indicating one of the image segments, the CPU 101 of the electronic watch 1a according to the second embodiment delays the timing until after completion of output of the image data indicating the one image segment. The CPU 101 can thus delay the timing of reversing the polarity of the AC voltage until a time point earlier than the time point after completion of output of the entire image data in the first embodiment. The configuration of the second embodiment can thus reduce the delay in the timing of reversing the polarity of the AC voltage and can therefore improve the reliability of the liquid crystal panel 20.

In addition, after completion of output of image data indicating one image segment in the ON state of the polarity reversal delay flag, the CPU 101 instructs the liquid crystal driver 108 to reverse the polarity of the AC voltage. In other words, the polarity of the AC voltage is reversed at a timing between the output of image data indicating the one image segment and the output of image data indicating another image segment to be displayed subsequent to the one image segment. The reversal of the polarity of the AC voltage is thus performed at the boundary between the two adjoining image segments and therefore is not readily noticed by a user viewing the liquid crystal panel 20.

### Third Embodiment

An electronic watch 1b according to the third embodiment will now be described. In the first or second embodiment, the CPU 101 of the electronic watch 1 or 1a executes the program 109 to function as the image data output controller 121 and the AC voltage output controller 122 or 122a. These functions, however, are not necessarily achieved by the software control by the CPU 101. In specific, a part or all of the functions of the CPU 101 according to the first or second embodiment may be achieved by any hardware configuration, such as dedicated logic circuitry. In the third embodiment, the function of the AC voltage output controller 122 in the first embodiment is achieved by hardware.

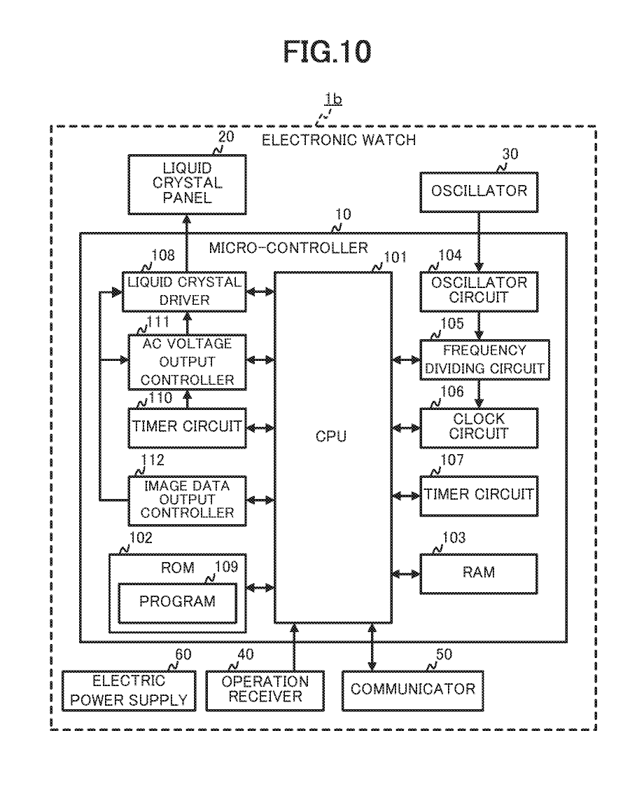

FIG. 10 illustrates an exemplary configuration of the electronic watch 1b according to the third embodiment. The configuration of the electronic watch 1b is identical to that of the electronic watch 1 according to the first embodiment, except that the functions of the AC voltage output controller 122 and the image data output controller 121 of the CPU 101 in the first embodiment are achieved by hardware, that is, a timer circuit 110, an AC voltage output controller 111, and an image data output controller 112 in the third embodiment. The components identical to those in the first embodiment are provided with the same reference signs without redundant description.

The timer circuit 110 counts cycles (for example, 0.5-second cycles) of reversing the polarity of the AC voltage. In response to the elapse of a cycle of reversing the polarity of the AC voltage from the start of counting, the timer circuit 110 outputs an AC-voltage output request signal to the AC voltage output controller 111.

In response to reception of the AC-voltage output request signal from the timer circuit 110 during an image data output period, the AC voltage output controller 111 instructs the liquid crystal driver 108 to output the AC voltage while maintaining the polarity. Then, after completion of output of the image data, the AC voltage output controller 111 instructs the liquid crystal driver 108 to output the AC voltage with the reversed polarity. In contrast, in response to reception of the AC-voltage output request signal from the timer circuit 110 not during an image data output period, the AC voltage output controller 111 instructs the liquid crystal driver 108 to output the AC voltage with the reversed polarity.

The image data output controller 112 instructs the liquid crystal driver 108 to output image data to the pixels 21 under the instructions from the CPU 101. In specific, for example, the image data output controller 112 generates image data to be output and records the image data into the RAM 103 under the instructions from the CPU 101. The image data output controller 112 then instructs the liquid crystal driver 108 to output the image data recorded in the RAM 103 to the pixels 21.

As described above, in the electronic watch 1b according to the third embodiment, the function of the AC voltage output controller 122 in the first embodiment is achieved by hardware. This configuration can reduce the processes executed by the CPU 101 and thereby reduce the load on the CPU 101 in comparison the first embodiment.

The above embodiments should not be construed to limit the present disclosure but may be modified in various manners.

For example, in the first to third embodiments, the liquid crystal driver 108 records image data into the respective memory elements 201 in the pixels 21, that is, the liquid crystal panel 20 is an MIP LCD. The liquid crystal driving device in the present disclosure, however, can also be applied to other types of liquid crystal panels than the MIP LCD. For example, the liquid crystal panel 20 may be a TFT LCD. It should be noted that the MIP LCD has a lower frequency of image replacement than the TFT LCD. If any error in image replacement occurs due to the overlapping between a timing of reversing the polarity of the AC voltage and the timing of outputting image data, the error display on the MIP LCD can continue for a longer time than that of the TFT LCD. Accordingly, the application of the liquid crystal driving device according to the present disclosure to the MIP LCD can prevent an error in image replacement and thereby improve the reliability of the MIP LCD.

In the second embodiment, the image indicated by image data to be output to the liquid crystal panel 20 contains the image segments A₁ to A₃ defined by dividing the image along boundaries extending in the lateral direction (scanning direction). Alternatively, the image segments A₁ to A₃ may be defined, for example, along boundaries extending in the longitudinal direction, instead of the boundaries extending in the lateral direction.

In the above embodiments, the ROM 102, which is a non-volatile memory, such as a flash memory, serves as a computer-readable recording medium storing the program 109 for control of the AC-voltage output control process and the image-data output control process in the present disclosure. Alternatively, the computer-readable recording medium may be any other portable recording medium, such as a hard disk drive (HDD), a compact disc read only memory (CDROM), or a digital versatile disc (DVD). Carrier waves may also function as a medium for providing data on the program in the present disclosure via a communication line.

Any specific detail, such as a configuration, control process, and exemplary display screen, illustrated in the above embodiments may be appropriately modified within the gist of the present disclosure.

The foregoing describes some example embodiments for explanatory purposes. Although the foregoing discussion has presented specific embodiments, persons skilled in the art will recognize that changes may be made in form and detail without departing from the broader spirit and scope of the present disclosure. Accordingly, the specification and drawings are to be regarded in an illustrative rather than a restrictive sense. This detailed description, therefore, is not to be taken in a limiting sense, and the scope of the present disclosure is defined only by the included claims, along with the full range of equivalents to which such claims are entitled.

What is claimed is:

1. A liquid crystal driving device comprising:
a liquid crystal driver that drives a liquid crystal panel in which a plurality of pixels are arranged; and
a processor that controls the liquid crystal driver, wherein
the processor
instructs the liquid crystal driver to output image data to the pixels, and
instructs the liquid crystal driver to output AC voltage while reversing a polarity of the AC voltage in predetermined cycles, the AC voltage being applied to display elements included in the respective pixels, and
when a timing of reversing the polarity is within a period of output of the image data, the processor delays the timing until after the period.

2. The liquid crystal driving device according to claim 1, wherein
the processor turns on an image-data output continuation flag at start of output of the image data, and
when the processor determines that the image-data output continuation flag is ON at the timing of reversing the polarity, the processor delays the timing until after the period of output of the image data.

3. The liquid crystal driving device according to claim 1, wherein
when the timing of reversing the polarity is within the period of output of the image data, the processor turns on a polarity reversal delay flag, and instructs the liquid crystal driver to output the AC voltage while maintaining the polarity, and
when the processor determines that the polarity reversal delay flag is ON after the period of output of the image data, the processor instructs the liquid crystal driver to output the AC voltage with the reversed polarity.

4. The liquid crystal driving device according to claim 2, wherein
when the timing of reversing the polarity is within the period of output of the image data, the processor turns on a polarity reversal delay flag, and instructs the liquid crystal driver to output the AC voltage while maintaining the polarity, and
when the processor determines that the polarity reversal delay flag is ON after the period of output of the image data, the processor instructs the liquid crystal driver to output the AC voltage with the reversed polarity.

5. The liquid crystal driving device according to claim 1, wherein
the image data indicates an image comprising a plurality of image segments, and
when the timing of reversing the polarity is within a period of output of part of the image data indicating one of the image segments, the processor delays the timing until after completion of output of the part of the image data indicating the image segment.

6. The liquid crystal driving device according to claim 2, wherein
the image data indicates an image comprising a plurality of image segments, and
when the timing of reversing the polarity is within a period of output of part of the image data indicating one of the image segments, the processor delays the timing until after completion of output of the part of the image data indicating the image segment.

7. The liquid crystal driving device according to claim 3, wherein
the image data indicates an image comprising a plurality of image segments, and
when the timing of reversing the polarity is within a period of output of part of the image data indicating one of the image segments, the processor delays the timing until after completion of output of the part of the image data indicating the image segment.

8. The liquid crystal driving device according to claim 4, wherein
the image data indicates an image comprising a plurality of image segments, and
when the timing of reversing the polarity is within a period of output of part of the image data indicating one of the image segments, the processor delays the timing until after completion of output of the part of the image data indicating the image segment.

9. The liquid crystal driving device according to claim 1, wherein the liquid crystal driver records the image data into memory elements included in the respective pixels.

10. The liquid crystal driving device according to claim 2, wherein the liquid crystal driver records the image data into memory elements included in the respective pixels.

11. The liquid crystal driving device according to claim 3, wherein the liquid crystal driver records the image data into memory elements included in the respective pixels.

12. The liquid crystal driving device according to claim 4, wherein the liquid crystal driver records the image data into memory elements included in the respective pixels.

13. The liquid crystal driving device according to claim 5, wherein the liquid crystal driver records the image data into memory elements included in the respective pixels.

14. The liquid crystal driving device according to claim 6, wherein the liquid crystal driver records the image data into memory elements included in the respective pixels.

15. The liquid crystal driving device according to claim 7, wherein the liquid crystal driver records the image data into memory elements included in the respective pixels.

16. The liquid crystal driving device according to claim 8, wherein the liquid crystal driver records the image data into memory elements included in the respective pixels.

17. An electronic watch comprising:
the liquid crystal driving device according to claim 1;
a counter that determines a current time; and
the liquid crystal panel that outputs image data indicating the current time determined by the counter.

18. A liquid crystal driving method executed by a liquid crystal driving device comprising a liquid crystal driver that drives a liquid crystal panel in which a plurality of pixels are arranged, the method comprising:
an image-data output control step of instructing the liquid crystal driver to output image data to the pixels; and
an AC-voltage output control step of instructing the liquid crystal driver to output AC voltage while reversing a polarity of the AC voltage in predetermined cycles, the AC voltage being applied to display elements included in the respective pixels, wherein
in the AC-voltage output control step, when a timing of reversing the polarity is within a period of output of the image data, the timing is delayed until after the period.

19. A computer-readable recording medium storing a program executed by a computer comprising a liquid crystal driver that drives a liquid crystal panel in which a plurality of pixels are arranged, wherein
the program causes the computer to function as:
an image data output controller to instruct the liquid crystal driver to output image data to the pixels; and
an AC voltage output controller to instruct the liquid crystal driver to output AC voltage while reversing a polarity of the AC voltage in predetermined cycles, the AC voltage being applied to display elements included in the respective pixels, and
when a timing of reversing the polarity is within a period of output of the image data, the AC voltage output controller delays the timing until after the period.
